(19) United States
(12) Patent Application Publication
(10) Pub. No.: US 2017/0291048 A1
(43) Pub. Date: Oct. 12, 2017

(54) RELEASABLE SLING DEVICE

(71) Applicant: Hole AS, Sykkylven (NO)

(72) Inventor: Jan-Gunnar Brunstad Hole, Sykkylven (NO)

(73) Assignee: Hole AS, Sykkylven (NO)

(21) Appl. No.: 15/510,273

(22) PCT Filed: Sep. 25, 2015
(86) PCT No.: PCT/EP2015/072082

§ 371 Date: Mar. 10, 2017

(30) Foreign Application Priority Data
Sep. 25, 2014 (NO) 20141160

(51) Int. Cl. A62B 35/00; B66C 1/14; A62B 35/04; B64D 1/02

(52) U.S. Cl. CPC A62B 35/0075; B64D 1/02; B66C 1/14; A62B 35/04

(57) ABSTRACT

A releasable sling device includes first, second, and third attachment devices. The first attachment device is configured to an elevating device. The second attachment device is configured to be attached to an object. The third attachment device configured to be attached to a structure. A connection element is connected between the first attachment device and the second attachment device. A securing device has a first end that is connected to the second attachment device and a second end that is connected via a releasable connection device to the third attachment device. A releaser element is connected between the first attachment device and the releasable connection device. The releasable connection device is configured to release the third attachment device from the securing device when the releaser element is pulled away from the releasable connection device with a predetermined force threshold.

### FIELD OF THE INVENTION

The present invention relates to a releasable sling device.

### BACKGROUND OF THE INVENTION

Occasionally, climbers or hikers experience accidents and a rescue operation must be performed in order to transport the person out from a steep mountain. Typically such an operation is performed by lowering a rescuer down from the top of the mountain. The rescuer will supply first aid to the person and put the person on a stretcher. A rescue helicopter is used to lift the stretcher up into the helicopter by means of a winch and a helicopter wire, while the rescuer is waiting. While waiting, the rescuer will for safety reasons be secured to the mountain by means of a climbing harness and a climbing bolt fixed to the mountain. Finally, the rescue helicopter is used to lift the rescuer up into the helicopter.

The rescuer now has to release the climbing harness from the bolt and connect the climbing harness to the helicopter wire that is lowered from the helicopter. The rescuer is under no circumstance allowed to secure the climbing harness to the climbing bolt and the helicopter wire at the same time, since this in reality will be to secure the helicopter to the mountain. The helicopter must have the freedom to maneuver if turbulence or severe weather conditions are present.

Hence, there will be situations where the rescuer is decoupled from both the helicopter and mountain bolt, and hence without fall protection.

There have been situations where the rescuer has passed out due to exhaustion, static electricity, injuries due to falling rocks etc, and where a separate rescue operation had to be performed for the rescuer. In such situations, it is preferable if the rescuer is secured to the helicopter wire, because the helicopter may then lift the rescuer into the helicopter.

US 2011/0042984 describes a device for securing rescue operations by helihoisting that comprises three attachment means, a first for the helicopter, a second for the rescuer and a third for the belay tether. Hence, it is here possible for the rescuer to be connected to the helicopter and to the belay tether at the same time. If the helicopter needs to maneuver away from the mountain, the connection between the device and the belay tether will be automatically released when a pulling force from the helicopter exceeds a predetermined threshold.

The disadvantage of this device is that it is rather complex with many relatively small parts, where snow and ice may prevent the device from functioning. It has also been discussed if this device will release when the helicopter is pulling in a direction perpendicular out from the mountain, which may be the case if the helicopter falls suddenly due to turbulence etc. Moreover, it is not possible to adjust the force required to release this device.

US 2004/050343 describes a method for providing fall protection for human and non-human loads in elevated environments. The load is equipped with a safety harness and lanyard apparatus having first and second lanyards attached thereto. The method includes the steps of: (1) connecting a safety lanyard apparatus to the load, said safety lanyard apparatus including first and second lanyards, each of said first and second lanyards having one end connected to the load and an opposing connectable free end, said first lanyard incorporating a means for automatic release of said connectable free end thereof in response to a predetermined tensional force; (2) connecting said first lanyard connectable free end to the aerial lift vehicle; (3) connecting said second lanyard connectable free end the structure, whereby the application of a tensional force, greater than or equal to a predetermined force, to said first and second lanyard ends results in activation of said means for automatic release thereby separating said connectable free end of said first lanyard from said safety lanyard apparatus thereby leaving said load suspended from said structure.

The main object of the present invention is to provide a device where it is possible for a person to be anchored to the helicopter and to the mountain at the same time, and where a safe release of the helicopter from the mountain is possible. Moreover, it is an object of the invention that the person should follow the helicopter upon such a release, i.e. the person should also be released from the mountain.

A further object is that the device should be reliable, it should be possible to perform a visual control of the status of the device and it should function even during bad weather conditions.

When a rescuer is lowered down from a helicopter, the rescuer never knows if there is a need to anchor himself to the mountain. A further object of the present invention is to provide a device where it is possible to do so in an easy way, without the need of a lot of extra equipment.

### SUMMARY OF THE INVENTION

The present invention is defined in the dependent claim 1. Preferred embodiments are defined in the independent claims.

### DETAILED DESCRIPTION

Embodiments of the invention will now be described in detail with reference to the enclosed drawings, where:

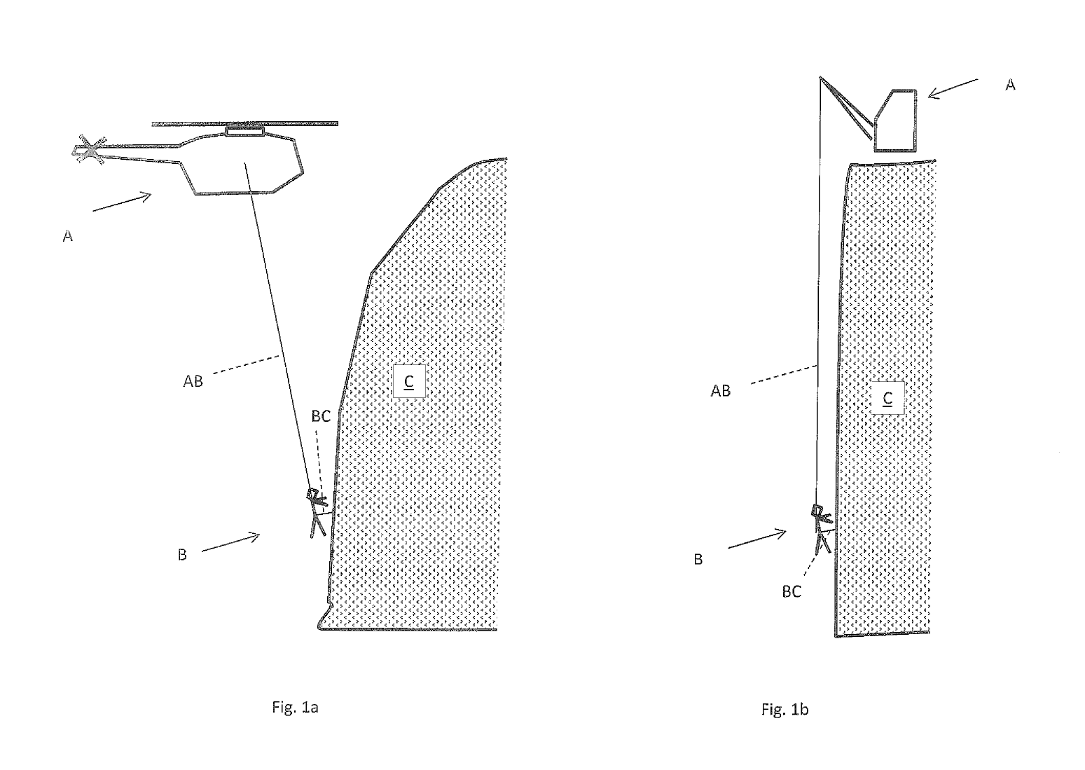

FIG. 1a illustrates a first situation in which the present invention can be used;

FIG. 1b illustrates a situation in which the present invention can be used;

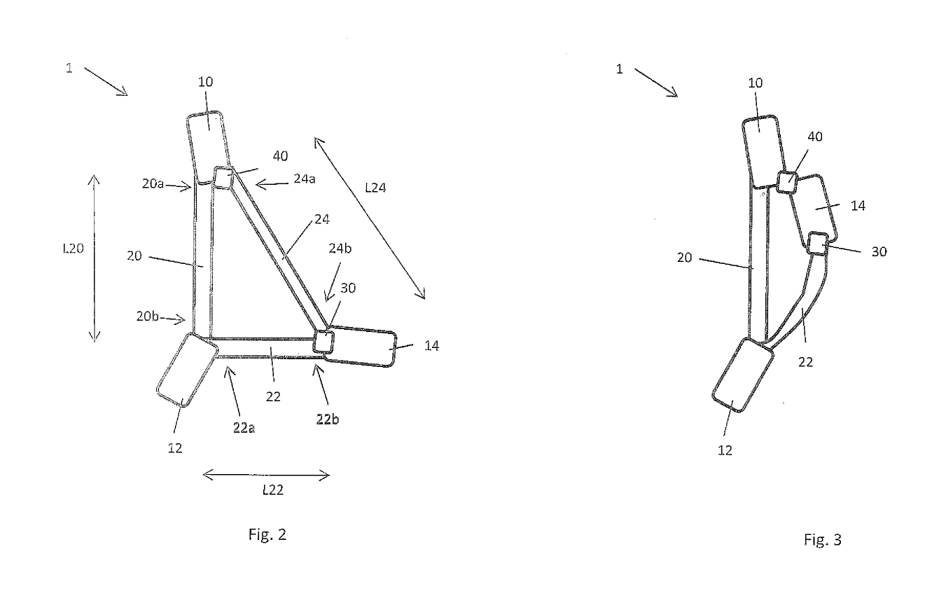

FIG. 2 illustrates a first embodiment schematically in a first state;

FIG. 3 illustrates the first embodiment schematically in a second state;

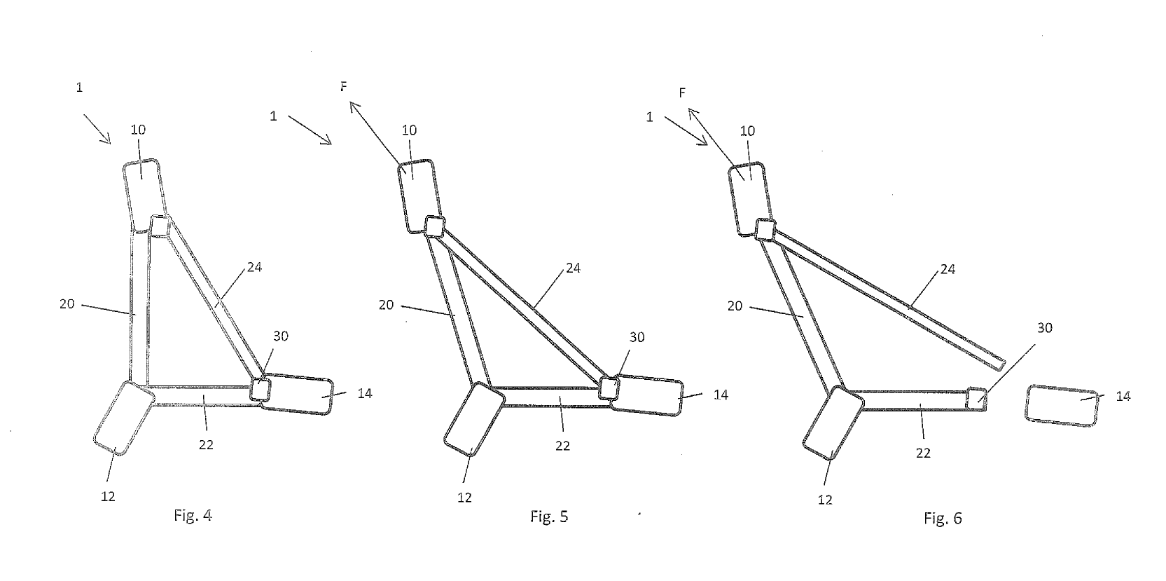

FIG. 4 illustrates the first embodiment schematically in its first state again;

FIG. 5 illustrates the first embodiment schematically on its way to a third, released state;

FIG. 6 illustrates the first embodiment schematically in the third, released state;

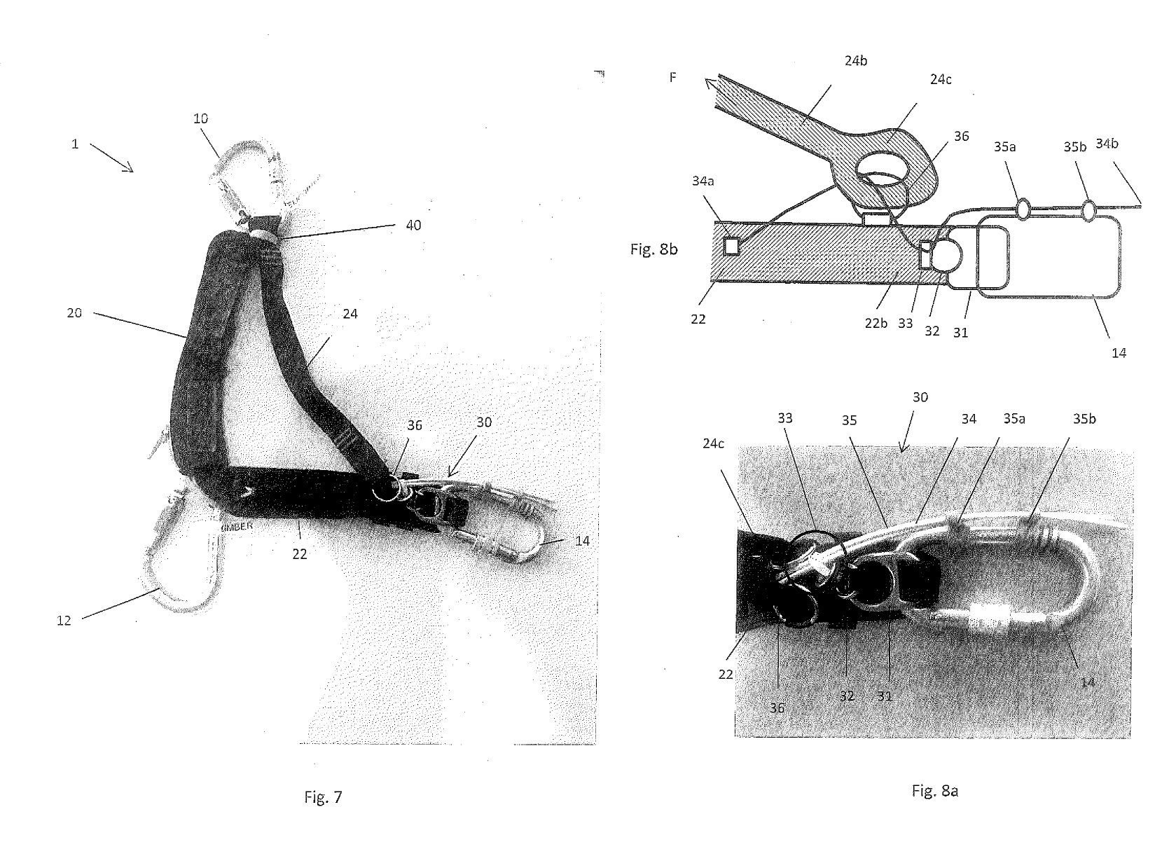

FIG. 7 shows an image of a prototype of the invention in the first state;

FIG. 8a shows an enlarged view of the releasable connection device;

FIG. 8b shows the releasable connection device schematically;

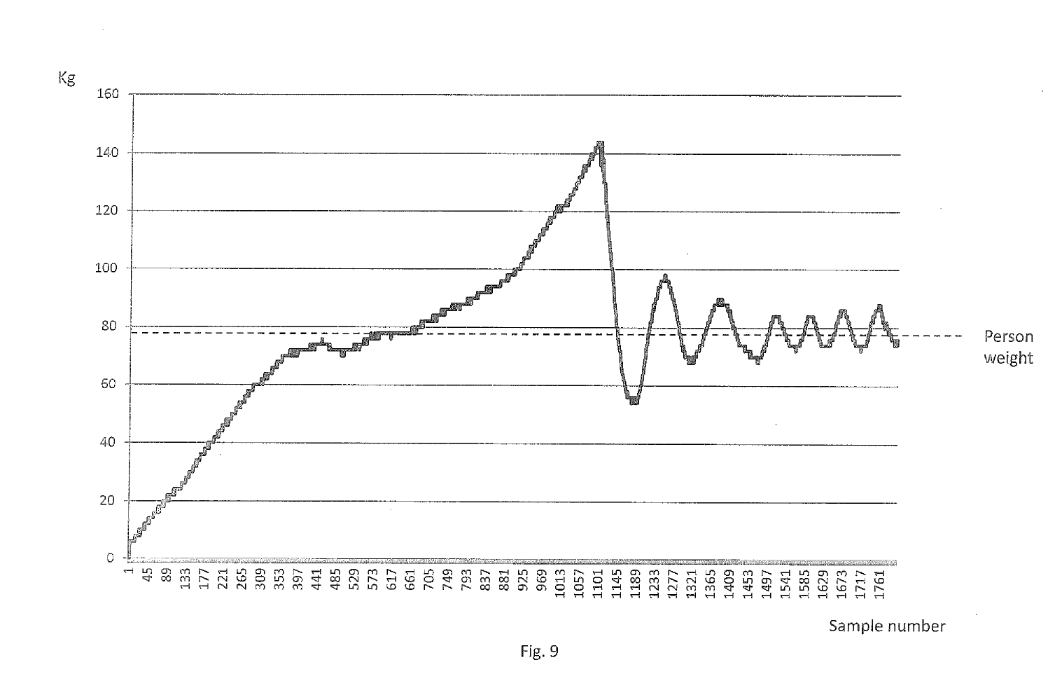

FIG. 9 shows the results of a test of the prototype.

It is now referred to FIG. 1a. Here, a helicopter A, a person B and a mountain C is shown. The person B is wearing a safety harness (not shown) and the person is using a releasable sling device 1 according to the present invention.

It is now referred to FIG. 2. The releasable sling device 1 comprises a first attachment device 10 configured to be attached to a wire AB of the helicopter A, a second attachment device 12 configured to be attached to the safety harness of the person B; and a third attachment device 14 configured to be attached to the mountain C, for example via a connection means BC to a climbing bolt (not shown) fixed to the mountain C.

In the first embodiment, the first, second and third attachment devices 10, 12 and 14 are carabiner hooks. Alternatively, other types of safety hooks, links or connectors can be used.

The releasable sling device 1 further comprises a fall energy absorbing device 20 connected between the first attachment device 10 and the second attachment device 12. A first end 20a of the device 20 is connected to the first attachment device 10 and a second end 20b of the device 20 is connected to the second attachment device 12.

Hence, if the person is falling from the mountain when being attached to the helicopter wire AB, then the fall energy absorbing device 20 may absorb the fall energy and the risk of injuries is reduced. The fall energy absorbing device 20 is considered to be known per se and will not be described further in detail here. The fall energy absorbing device 20 may for example be a Petzl Absorbica (see http://www.petzl.com/en/Professional/Lanyards-and-energy-absorbers/ABSORBICA) or a corresponding product from Petzl or other producers.

The releasable sling device 1 further comprises a securing device 22. As indicated in FIG. 2, a first end 22a of the securing device 22 is connected to the second attachment device 12 and a second end 22b of the securing device 22 is connected via a releasable connection device 30 to the third attachment device 14. The securing device 22 may be any type of web, rope, wire etc suitable for being connected between the person B and the mountain C, as described above. The securing device is preferably flexible.

The releasable sling device 1 further comprises a releaser element 24 connected between the first attachment device 10 and the releasable connection device 30. The releaser element 24 may be any type of web, rope, wire etc. The releaser element is preferably flexible.

As indicated in FIG. 2, a first end 24a of the releaser element 24 is connected to the first attachment device 10 and a second end 24b of the releaser element 24 is connected to the releasable connection device 30. The purpose of the releaser element 24 is to activate the releasable connection device 30, as will be described in detail below.

The releasable connection device 30 is configured to release the third attachment device 14 from the securing device 22 when the releaser element 24 is pulled away from the releasable connection device 30 with a predetermined force threshold.

It is now referred to FIG. 3. Here it is shown that the releasable sling device 1 comprises an attaching element 40 provided on the fall energy absorbing device 20 or releaser element 24 in the proximity of the first attachment device 10 or provided on the first attachment device 10. This can be used when the person is hanging from the helicopter. It is now possible to connect the third attachment 14 to the attaching element 40, reduce the risk for the releaser element 24 and securing device 22 to be entangled. The attaching element 40 may be a rubber band etc, in order to ensure that attachment element 40 will not prevent the function of the fall energy absorbing device 20.

In the present embodiment, the releasable connection device 30 is a three-ring release system, as shown in FIGS. 7 and 8. The term three-ring release system is used herein to comprise the original tree-ring release system described in U.S. Pat. No. 4,337,913 and its alternatives called the mini ring release system” and Aerodynes miniforce system described in U.S. Pat. No. 6,983,913. The three-ring release system is considered known from http://en.wikipedia.org/wiki/3-ring release system, and will not be described in detail herein. The term three-ring release system is considered to comprise the variant referred to as a four-ring release system.

In the enlarged view of FIG. 8, a first ring of the three-ring release system is the attachment device 14. A second ring of the three-ring release system is indicated by reference number 31. A third ring of the three-ring release system is indicated by reference number 32. A cord loop and a grommet of the three-ring release system are indicated by a white circle 33 in FIG. 8a.

A semi-rigid cable of the three-ring release system is indicated by reference number 34 in FIG. 8a, where a first end 34a is fixed to the securing device 22 and a second end of the semi-rigid cable 34 is connected to the attachment device 14 by means of rubber bands 35a, 35b, which gives the user a possibility to visually inspect of the state of the releasable sling device 1.

As shown in FIG. 8a, the second ring 31 is an elongated ring device similar to the ring from the Aerodyne miniforce system.

In the present embodiment, the second end 24b of the releaser element 24 comprises a loop 24c, through which the semi-rigid cable 34 is guided, as illustrated schematically in FIG. 8b.

The releasable connection device 30 further comprises a weak link device 36 connected between loop 24c and the second end 22b of the securing device 22, as indicated in FIG. 8b. Here, the weak link device 36 comprises a snap ring.

The releasable connection device 30 is configured to release the third attachment device 14 from the securing device 22 when the releaser element 24 is pulled in a direction towards the first attachment device 10.

The releasable sling device 1 is now used in the situation of FIG. 1a. Here, the person is attached simultaneously to both to the helicopter via the first attachment device 10 and to the mountain via the third attachment device 14. If a situation occurs in which the helicopter has to move away from the mountain, the first attachment device 10 will become pulled away from the third attachment device 14 because of the pulling force F from the helicopter wire. This is shown in FIG. 5. It should be noted that the pulling force F from the helicopter will increase since the device 1 is still attached to the mountain C via attachment device 14.

It is now referred to FIG. 8b. As the pulling force F of the releaser element 24 is increasing, the snap ring 36 of the releasable connection device 30 will snap at a predetermined force. Then, the releaser element 24 will be able to move further away from the second end 33b of the securing device 22. Hence, the semi-rigid wire 34 will be pulled out from the rubber bands 35a, 35b and out of the cord loop and grommet indicated by reference number 33. This will release the third ring 32, which again will release the second ring 31 and finally, the first ring (i.e. the third attachment device 14) will be released, as indicated in FIG. 6.

The person is now released from the mountain, and the helicopter is free to maneuver away from the mountain, with the person hanging in the helicopter wire AB under the helicopter.

It is now referred back to FIG. 2, where it is shown that a length L24 of the releaser element 24 is shorter than the sum of a length L20 of the fall energy absorbing device 20 and a length L22 of the the securing device 22. Preferably, the length L24 of the releaser element 24 is at least 5% shorter than the sum of the length L20 of the fall energy absorbing device 20 and the length L22 of the securing device 22.

In a test of a prototype, one snap ring 36 have been used, having a predetermined snap threshold of 431 N (corresponding to a weight of 44 kg). Of course, the snap rings may be replaced by other types of weak links having other snap thresholds. It should be noted that in the final product, the plan is to use two such snap rings 36 in order to increase the snap threshold.

It is now referred to FIG. 9, where the result of a test of the prototype described above is shown. In the test, a person with a safety harness was secured to a wall via the third attachment device 14 of the releasable sling device 1 described above. The weight of the person including clothing etc was ca 78 kg.

The first attachment device 10 was connected to a crane, where a weight measurement device in the form of a weight cell was connected to the crane wire in order to measure the pulling weight from the crane. The weight cell was sampling measurements each 1/30 of a second. The pulling direction was ca 25° in relation to the vertical direction, out from the wall.

In the beginning, the person is hanging from the wall, and the pulling weight is gradually increasing.

In the area around sample number 485, there is a flattened area caused by the pulling weigh becoming equal to the person weight. The person is here gradually being lifted by the crane.

As the pulling weight increases, the releaser element 24 is gradually pulled away from the releasable connection device 30.

When the pulling weight reaches about 143 kg, the snap rings 36 are snapping and the releasable connection device 30 is released. The person is now no longer attached to the wall, and the person is swinging back and forth under the crane. There are some fluctuations in the pulling weight which are gradually dampened around the person weight. The pulling weight of 143 kg corresponds to the sum of the person weight (ca 78 kg), the snap ring threshold (44 kg) and an additional weight of ca 21 kg assumed to be caused mainly by the pulling angle and friction.

Alternative embodiments

It should be noted that the helicopter A may be another type of elevating device, for example a lift, a crane, a pulley system etc. It should also be noted that the person B may be another type of objects, for example a load in the form of tools, building materials, a container etc. It should also be noted that the mountain C may be another type of structure, for example a tall building, a part of an offshore oil and/or gas platform, a part of a vessel etc.

In FIG. 1b, it is shown that the elevating device A is a crane, the object B is a person and the structure C is a leg of an offshore platform, for example made of concrete. The person is elevated down into the leg to do a maintenance operation, and in order to be effective and be able to use both his hands, he is then fixing himself to the leg. If the person passes out, for example due to lack of oxygen or other injuries etc, it is important that the crane can lift the person up without the time consuming operation of sending a rescuer down to release the person from the leg.

It should be noted that the first end 24a of the releaser element 24 may be connected to the first end 20a of the fall energy absorbing device 20, i.e. in this case the releaser element 24 will be indirectly connected to the first attachment device 10.

In similar ways, it is possible that the first end 20a is connected to the first end 24a and hence the device 20 is indirectly connected to the first attachment device 10.

It should be mentioned that another type of connection element may be used between the first attachment device 10 and the second attachment device 12. It would be possible to use a web, a climbing rope, or other types of connection elements instead of the fall energy absorbing device 20. A fall energy absorbing device 20 could for example be connected between the helicopter wire and the first attachment device 10. Alternatively, during some operations, a fall energy absorbing device 20 is not required at all.

1. A releasable sling device comprising:
a first attachment device ;
a second attachment device configured to be attached to an object;
a third attachment device;
a connection element connected between the first attachment device and the second attachment device;
a securing device having a first end connected to the second attachment device and a second end connected via a releasable connection device to the third attachment device; and
a releaser element;
wherein the releasable connection device is configured to release the third attachment device from the securing device when the releaser element is pulled away from the releasable connection device with a predetermined force threshold,
wherein the first attachment device is configured to be attached to a wire of an elevating device,
wherein the third attachment device configured to be attached to a structure, and
wherein the releaser element is connected between the first attachment device and the releasable connection device.

2. The releasable sling device according to claim 1, wherein a length of the releaser element is shorter than a sum of a length of the connection element and a length of the securing device.

3. The releasable sling device according to claim 1, wherein a length of the releaser element is at least 5% shorter than a sum of a length of the connection element and a length of the a securing device.

4. The releasable sling device according to claim 1, wherein the releasable connection device is a three-ring release system.

5. The releasable sling device according to claim 4, where the releasable connection device comprises a weak link device connected between the releaser element and the securing device, wherein the three-ring release system is released when the weak link is snapping.

6. The releasable sling device according to claim 5, wherein the weak link device comprises one or more snap rings.

7. The releasable sling device according to claim 1, wherein the releasable connection device is configured to release the third attachment device from the securing device when the releaser element is pulled in a direction towards the first attachment device.

8. The releasable sling device according to claim 1, wherein the first attachment device, the second attachment device and/or the third attachment device are carabiner hooks.

9. The releasable sling device according to claim 1, further comprising an attaching element provided on the connection element or releaser element in the proximity of the first attachment device or provided on the first attachment device.

10. The releasable sling device according to claim 1, wherein the connection element is a fall energy absorbing device.

11. The releasable sling device according to claim 2, wherein the releasable connection device is a three-ring release system.

12. The releasable sling device according to claim 11, where the releasable connection device comprises a weak link device connected between the releaser element and the securing device, wherein the three-ring release system is released when the weak link is snapping.

13. The releasable sling device according to claim 12, wherein the weak link device comprises one or more snap rings.

14. The releasable sling device according to claim 3, wherein the releasable connection device is a three-ring release system.

15. The releasable sling device according to claim 14, where the releasable connection device comprises a weak link device connected between the releaser element and the securing device, wherein the three-ring release system is released when the weak link is snapping.

16. The releasable sling device according to claim 15, wherein the weak link device comprises one or more snap rings.
